(19) United States
(12) Patent Application Publication
(10) Pub. No.: US 2014/0246264 A1
(43) Pub. Date: Sep. 4, 2014

(54) FULL HYDRAULIC POWER STEERING WITH POSITIVE FORCE FEEDBACK

(71) Applicant: Mark L. Alderson, Brownsburg, IN (US)

(72) Inventor: Mark L. Alderson, Brownsburg, IN (US)

(21) Appl. No.: 14/196,542

(22) Filed: Mar. 4, 2014

Related U.S. Application Data
(60) Provisional application No. 61/772,252, filed on Mar. 4, 2013.

(51) Int. Cl. B62D 5/07; B62D 5/12

(52) U.S. Cl. CPC B62D 5/07; B62D 5/12
USPC 180/422; 180/432

(57) ABSTRACT

A force feedback system including a first hydraulic cylinder operably coupled to one or more tires of a vehicle, a power assist steering unit operably coupled to the one or more tires of the vehicle, and a second hydraulic cylinder operably coupled to the power assist steering unit, wherein the first and second hydraulic cylinders are hydraulically coupled to transmit force between the first and second hydraulic cylinders.

### CROSS REFERENCE TO RELATED APPLICATION

This application claims the benefit of and incorporates by reference herein the disclosure of U.S. Ser. No. 61/772,252, filed Mar. 4, 2013.

### TECHNICAL FIELD OF THE DISCLOSURE

The embodiments herein generally relate to vehicle steering systems and, more particularly, to a full hydraulic vehicle steering unit.

### BACKGROUND

As is known in the art, rack and pinion gears, with hydraulic power assist, are commonly used in vehicle steering systems. The steering rack receives mechanical input through a connection with the driver's steering wheel, such that turning of the steering wheel results in a pinion gear rotating and moving the steering rack which is connected through mechanical links to move the vehicle wheels. Power assist is provided by actuating a hydraulic fluid pump in response to the steering wheel input provided by the driver such that pressurized hydraulic fluid acts upon one or more pistons connected to the steering rack in order to decrease the effort required by the driver to steer the vehicle.

In a full hydraulic power steering system, there is no mechanical link between the steering unit that is connected to the steering wheel and the hydraulic cylinder that moves the steered wheels of the vehicle. In some applications it is not desirable or even possible to have a mechanical linkage between the driver's steering wheel and the steered wheels. A few examples are so-called monster trucks, some desert race trucks, rock crawling off road vehicles, forklift vehicles, and some mining and farm equipment. Monster trucks, desert race trucks, and rock crawlers are designed to operate near the limit of traction. The driver, in order to operate at that limit, gets a majority of the information as to how close he is to that limit from the feedback through the steering wheel. This feedback is essential to operating the vehicle at its limit. It is known in the industry that full hydraulic steering systems provide limited feedback.

A need remains for direct feedback from the wheels to the steering wheel with only hydraulic lines connecting the steering unit to the wheels.

### SUMMARY OF THE DISCLOSED EMBODIMENTS

In one aspect, a force feedback system is disclosed including, a first hydraulic cylinder operably coupled to one or more tires of a vehicle, a power assist steering unit operably coupled to the one or more tires of the vehicle, and a second hydraulic cylinder operably coupled to the power assist steering unit, wherein the first and second hydraulic cylinders are hydraulically coupled to transmit force between the first and second hydraulic cylinders. In one embodiment, the force feedback system may include a third hydraulic cylinder operably coupled to one or more tires of a vehicle, wherein the third hydraulic cylinder provides force to move one or more tires of the vehicle. In one embodiment, the first hydraulic cylinder may include a first hydraulic cylinder first end and a first hydraulic cylinder second end, the second hydraulic cylinder may include a second hydraulic cylinder first end and a second hydraulic cylinder second end and the first hydraulic cylinder first end may be operably coupled to the second hydraulic cylinder second end and the first hydraulic cylinder second end may be operably coupled to the second hydraulic cylinder first end. In one embodiment, a force may be transmitted from one of the first or second hydraulic cylinder to the other of the first or second hydraulic cylinder.

In one embodiment, the force feedback system may include a needle valve and a hydraulic cylinder with at least two ends, wherein the needle valve may operably couple the two ends via a line. In one embodiment, the needle valve may be solenoid controlled. In one embodiment, the force feedback system may include a microcontroller and a sensor, wherein the microcontroller may be operably coupled to control the needle valve and operate the needle valve when the sensor reads that one or more tires is no longer clocked.

In one embodiment, the force feedback system may further include a reservoir, a valve, and a port in at least one of the first or second hydraulic cylinders, wherein the valve operably couples the reservoir to the port. In one embodiment, the port is located at a point to release air trapped in the system. In one embodiment, the force feedback system may further include a microcontroller, a valve and a sensor, wherein the microcontroller may operate the valve when a condition is triggered by the sensor. In one embodiment, the condition may be excess pressure in the force feedback system, or excess movement in the force feedback system. In one embodiment, the valve is a three position four port solenoid valve with a center position normally closed.

In one embodiment, the force feedback system second hydraulic cylinder may include a steering rod and a piston ballscrew nut, wherein the piston ballscrew nut may be operably coupled to the second hydraulic cylinder and the steering rod. In one embodiment, the power assist steering unit may be mechanically and hydraulically coupled to one or more tires of a vehicle and the first hydraulic cylinder.

In one aspect, a method of operating a force feedback system is disclosed comprising the steps of (a) calculating an offset angle between a steering wheel and a vehicle's tire, (b) calculating the number of oil injections required to correct the offset angle, and (c) injecting the number of oil injections to correct the offset angle. In one embodiment, calculating the offset angle may further include the steps of (a) monitoring a position sensor operably coupled to a hydraulic cylinder for a stable condition and the hydraulic cylinder may be operably coupled the vehicle's tire, and (b) reading a steering wheel angle sensor operably coupled to the steering wheel. In one embodiment, the first hydraulic cylinder may be operably coupled to the vehicle's tire and the second hydraulic cylinder may be operably coupled to the steering wheel. In one embodiment, the oil injections may be injected into the first hydraulic cylinder or the second hydraulic cylinder. In one embodiment, the number of oil injections may be limited by the offset angle value.

### BRIEF DESCRIPTION OF THE DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a perspective view of a force feedback circuit in accordance with an embodiment. The microprocessor and electronic circuitry of the force feedback system are not illustrated in FIG. 1.

FIG. 2 is a perspective view of the force feedback circuit connected to a rack and pinion gear set in accordance with an embodiment.

FIG. 3 is a schematic view of a microcontroller of the force feedback circuit in accordance with an embodiment.

FIG. 4 is a schematic view of a force feedback circuit in accordance with another embodiment.

FIG. 5 is a schematic view of a portion of the force feedback circuit coupled to a piston in accordance with an embodiment.

FIG. 6 is a schematic view of an open loop and closed loop system for the force feedback circuit in accordance with an embodiment.

FIG. 7 is a schematic view of a microcontroller used with the force feedback circuit in accordance with an embodiment.

FIG. 8 is a flowchart of a method for clocking the steering wheel and tires of a vehicle in accordance with an embodiment.

### DETAILED DESCRIPTION OF THE VARIOUS EMBODIMENTS

For the purposes of promoting an understanding of the principles of the present disclosure, reference will now be made to the embodiments illustrated in the drawing, and specific language will be used to describe the same. It should be appreciated that not all of the features of the components of the figure are necessarily described. Some of these non-discussed features, as well as discussed features are inherent from the figures. Other non-discussed features may be inherent in component geometry and/or configuration. It will nevertheless be understood that no limitation of the scope of this disclosure is thereby intended.

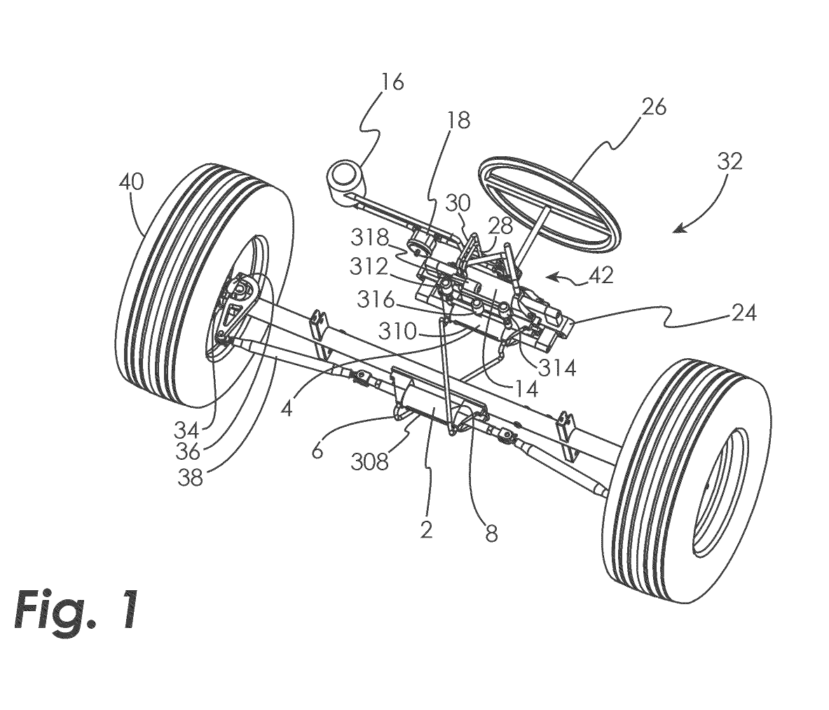

As referenced in FIG. 1, the force feedback system consists of two cylinders, with one cylinder 2 connected to the tires (40 controlling the vehicle and the other cylinder 4 connected to a rack and pinion power assist steering unit 32 which provides the power assist through cylinder 14. These two cylinders are then connected with a hydraulic line 6 that connects one end of cylinder 2 to the opposite end of cylinder 4, and the second end of cylinder 2 is connected by another line 8 to the remaining end of cylinder 4. This arrangement reproduces the forces and movements generated by the tires 40 acting through the hubs 34, spindles 36, and the tie rods 38 to the first feedback cylinder 2 through the hydraulic lines 6 and 8 to the second feedback cylinder 4.

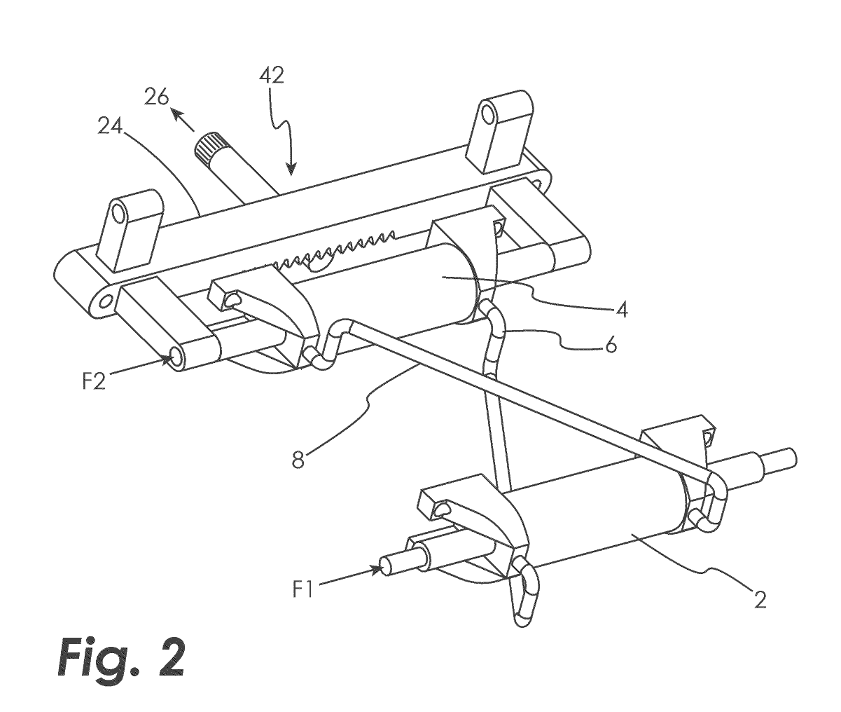

Now referencing FIG. 2, a force (F1) acting on the cylinder 2 (for example, by forces acting on the wheels 40 and transmitted to the cylinder 2) is transmitted by the lines 6,8 to the cylinder 4 to create the force (F2). This force (F2) and/or movement is fed directly into the rack 24 then to the pinion 42 which is directly connected to the driver steering wheel 26 of FIG. 1. Such transmission of the force acting on cylinder 2 to the driver steering wheel 26 provides the desired feedback to the driver, such that the driver can feel through the steering wheel 26 what is happening to the tires 40, which he may not be able to see. The converse is also true, any force and/or movement generated at the rack and pinion 24 is reproduced at the tie rods 38, spindles 36, hubs 34, and then the tires 40. This system not only gives the driver a direct feedback from the tires 40 but it has the added advantage that in the case of complete hydraulic power steering failure he can still steer the vehicle. One of the advantages of this system is that it can be used with known high performance steering units that have well established feel and performance characteristics.

It is well known in the art that in full hydraulic steering systems it is difficult to keep the steering wheel position matched to the position of the front wheels. In the event that fluid seeps from one end of a force feedback cylinder to the other end past the seal at the piston, the straight ahead position at the steering wheel 26 will not be the straight ahead position of the tires 40 causing the vehicle to continue to turn. When the driver steering wheel 26 and the tires 40 are in the straight ahead position at the same time they are clocked in position. When the clocking of the unit changes, it can be alarming to the driver and cause the driver to lose confidence in his ability to operate at the limit.

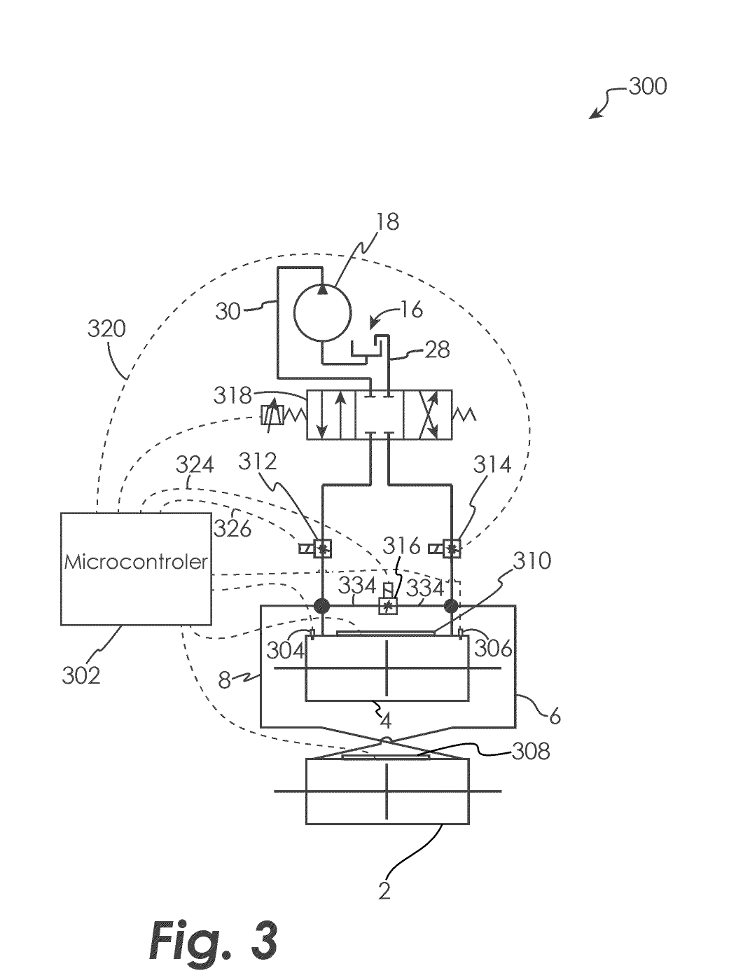

Referring now to FIG. 3, in short time periods of operation, leakage past the piston will not present much of a problem; however, in long term operation, sensors 308 and 310 can be mounted on the cylinders to determine when the cylinders are not clocked in the correct position. This information is then fed to a microcontroller 302 that also tracks fluid pressure (by use of pressure sensors 304 and 306) in both ends of the cylinder 4. To correct the situation where the system is not clocked in position, a line 334 is provided to connect the two ends of one of the force feedback cylinders. Line 334 includes a small orifice and a solenoid controlled needle valve 316 mounted in the middle of line 334. When a significant movement in the clocking of the two cylinders is recognized, a correction will be made by activating the needle valve 316 when the pressure differential in the cylinder is in the right direction. This will move fluid from one side of the piston to the other side as needed, reclocking the piston. Activating the needle valve 316 simply acts to (at least partially) equalize the pressure on each side of the piston. Therefore, if the pressure differential is not in the correct direction to accomplish reclocking of the piston, the system will wait until the pressure differential is in the correct direction before activating the needle valve 316.

Other issues to be dealt with are excessive pressure developed in a closed system due to heat expansion, replacing fluid in the event of a leak, and bleeding air from the system which would cause a soft or mushy feel with loss of steering effectiveness.

In the situation of excessive pressure, fluid can be moved to reservoir 16 from either side of the force feedback system by moving valve 318 to the proper position to remove fluid from the side desired through line 28 to reservoir 16, then sending a command through conductor 320 or 326 depending on the side desired. This will tell the solenoid operated needle valve 312 or 314 to open and allow fluid to pass through a small orifice. Fluid can be put into either side of the force feedback system by moving the valve 318 to put pump pressure line 30 from pump 18 to the desired solenoid operated needle valve 312 or 314 and then sending a command through conductor 324 or 326 depending on the side desired.

If the microcontroller senses excessive movement between the two pistons in the force feedback system, it could be assumed that there is air trapped in the system. If properly plumbed, the air will find its way to the highest point in the system and can then be removed by bleeding. That point is intended to be the port at each end of cylinder 4. The microcontroller can bleed the system by moving valve 318 to the proper position to remove fluid/air from one side of the system and put pressure in the other side, then sending a command through conductor 324 and 326 to open the solenoid operated needle valve 312 and 314. This operation can then be reversed to bleed the other port and reclock the system.

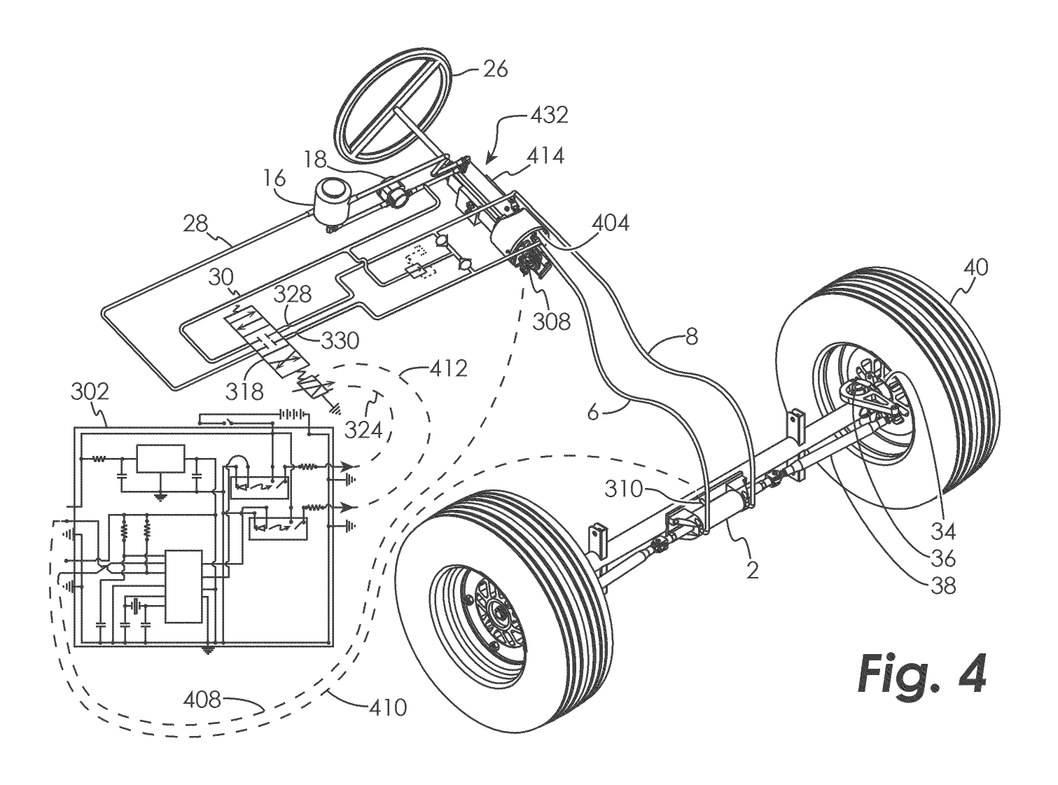

In another embodiment, as referenced in FIG. 4, the force feedback system is a closed loop hydraulic circuit that consists of two cylinders, with one cylinder 2 connected to the tires 40 controlling the vehicle and the other cylinder 404 connected to the power assist steering unit 432 which provides the power assist through a mechanical connection from cylinder 414. These two force feedback cylinders are then connected with a hydraulic line 6 that connects one end of cylinder 2 to the opposite end of cylinder 404, and the second end of cylinder 2 is connected by another line 8 to the remaining end of cylinder 404. This arrangement reproduces the forces and movements generated by the tires 40 acting through the hubs 34, spindles 36, and the tie rods 38 to the first feedback cylinder 2 through the hydraulic lines 6 and 8 to the second feedback cylinder 404.

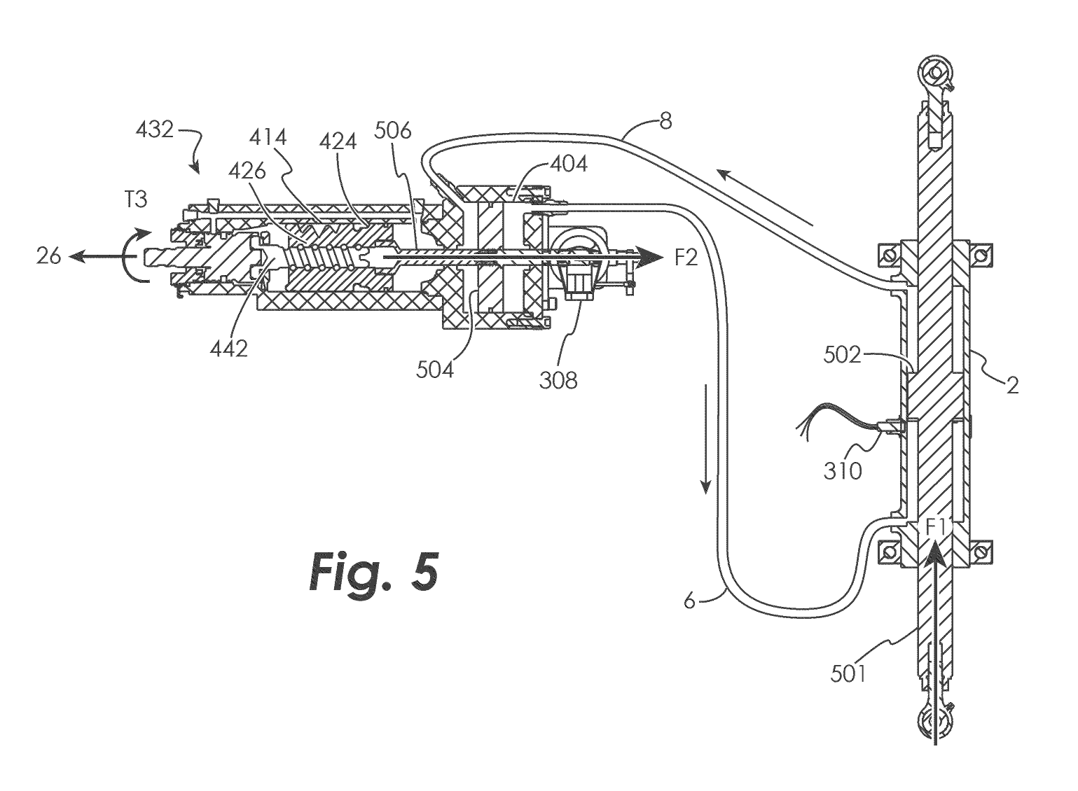

Now referencing FIG. 5, a force and/or movement (F1) acting on the piston rod 501 to the piston 502 and into the hydraulic fluid of cylinder 2 is transmitted by the lines 6,8 to the cylinder 404 and piston 504 to create the force and/or movement (F2). This force and/or movement (F2) is transmitted to the piston/ballscrew nut 424 by rod 506. The Ballscrew nut 426 in piston 424 then changes the linear force and/or movement to a rotational torque and/or rotational movement in ball screw 442 which is directly connected to the driver steering wheel 26 of FIG. 4. Such transmission of the force acting on cylinder 2 to the driver steering wheel 26 provides the desired feedback to the driver, such that the driver can feel through the steering wheel 26 what is happening to the tires 40. The converse is also true, any force and/or movement generated at the steering box 432 is reproduced at the tie rods 38, spindles 36, hubs 34, and then the tires 40. This system not only gives the driver a direct feedback from the tires 40 but it has the added advantage that in the case of complete hydraulic power steering failure he can still steer the vehicle. Another advantage of this system is that it can be used with known high performance steering servos that have well established feel and performance characteristics.

It is well known in the art that in full hydraulic steering systems it is difficult to keep the steering wheel position synchronized with the position of the front wheels. In the event that fluid seeps from one end of a force feedback cylinder to the other end past the seal at the piston, the straight ahead position at the steering wheel 26 will not be the straight ahead position of the tires 40 causing the vehicle to continue to turn. When the driver steering wheel 26 and the tires 40 are in the straight ahead position at the same time they are clocked in position. When the clocking of the unit changes, it can be alarming to the driver and cause the driver to lose confidence in his ability to operate at the limit.

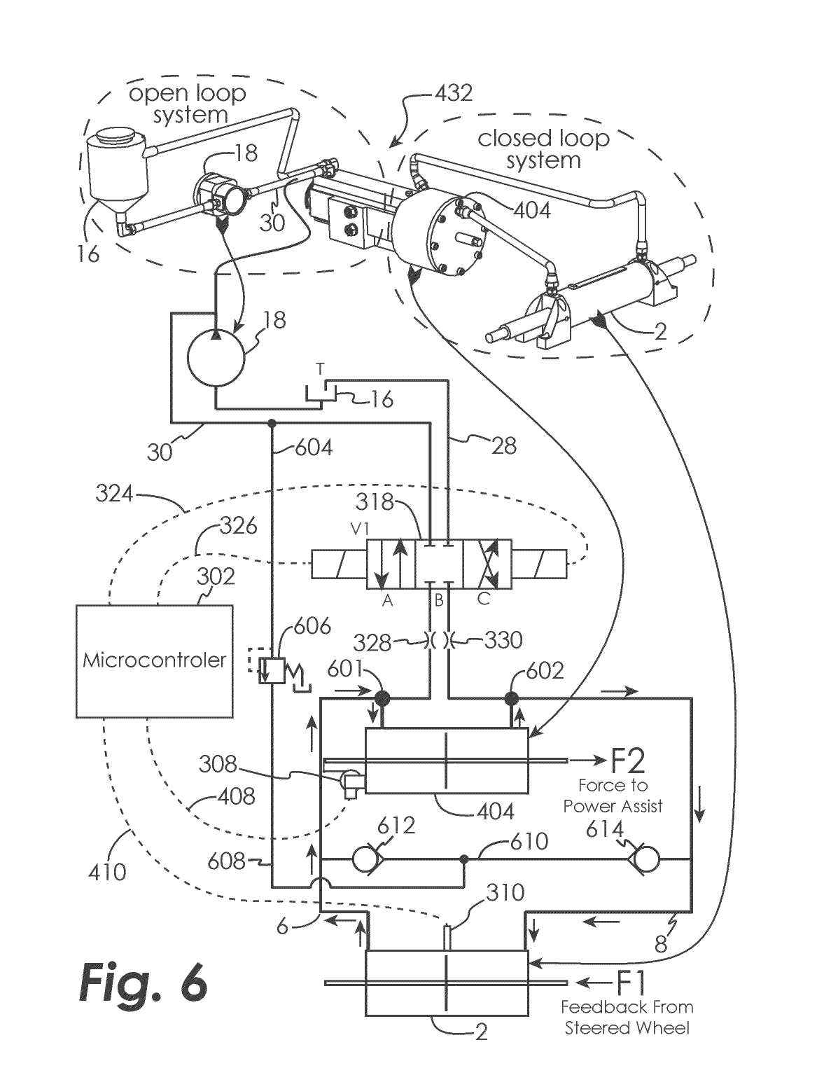

Referring now to FIG. 6, in short time periods of operation, leakage past the piston will not present much of a problem. However, in long term operation, linear position sensor 308 through connector 408, and proximity sensor 310 through connector 410 can be monitored by microcontroller 302 to determine when the cylinders are not clocked in the correct position. The controller is able to move the steered wheels relative to the steering wheel position by moving the solenoid valve 318 by a signal through connector 326 right or connector 324 left depending on the direction required. The solenoid valve 318 is a 3 position 4 port valve with the center position normally closed. The rate at which the feedback pistons are moved will be dependent on the length of time the valve is open, the size of the orifice restrictors 328 330 in the line, and the pressure differential. The valve 318 may be opened several times for short intervals to slowly bring the piston back into position.

In the situation of excessive residual pressure in the system due to a non-compressible fluid being heated in a fixed volume, a small amount of fluid will have to be removed from the system. When the valve 318 is cycled the pressure drop between the pump and the cylinder would be less and the pressure drop between the cylinder and the reservoir (vented to atmosphere) would be greater. This would produce a more rapid flow out to the tank thus dropping the pressure in the close loop system.

If properly plumbed, the air will find its way to the highest point in the system and can then be removed by bleeding. Locating bleed points 601 and 602 at the top of cylinder 404, the highest points in the force feedback closed loop circuit and providing a cavity for air to collect in will provide a point from which air can be bled from the system. Every time valve 318 is cycled one side of the system will bleed to tank. This operation can then be reversed to bleed the other port and reclock the system.

Still referring to FIG. 6, replacing fluid and maintaining a positive pressure in the system is characteristic of closed loop systems. It is well known in the art that closed loop systems require a charge pump and charging circuit to replace fluid lost during operation and to maintain pressure in the system for smooth operation and prevent air ingestion. The system consist of power steering pump 18, supply line 604, pressure regulator 606, connecting lines 608 610, and check valves 612 614. The pressure regulator 606 is supplied through line 604. The pressure regulator 606 is set to a pressure just high enough to prevent any air from being sucked into the system past the seals. The check valves 612 614 will prevent any fluid from leaving the closed loop circuit, but if the pressure in either side of the circuit should drop below the predetermined level the check valve 612 and/or 614 will open and the circuit brought back to that operating pressure.

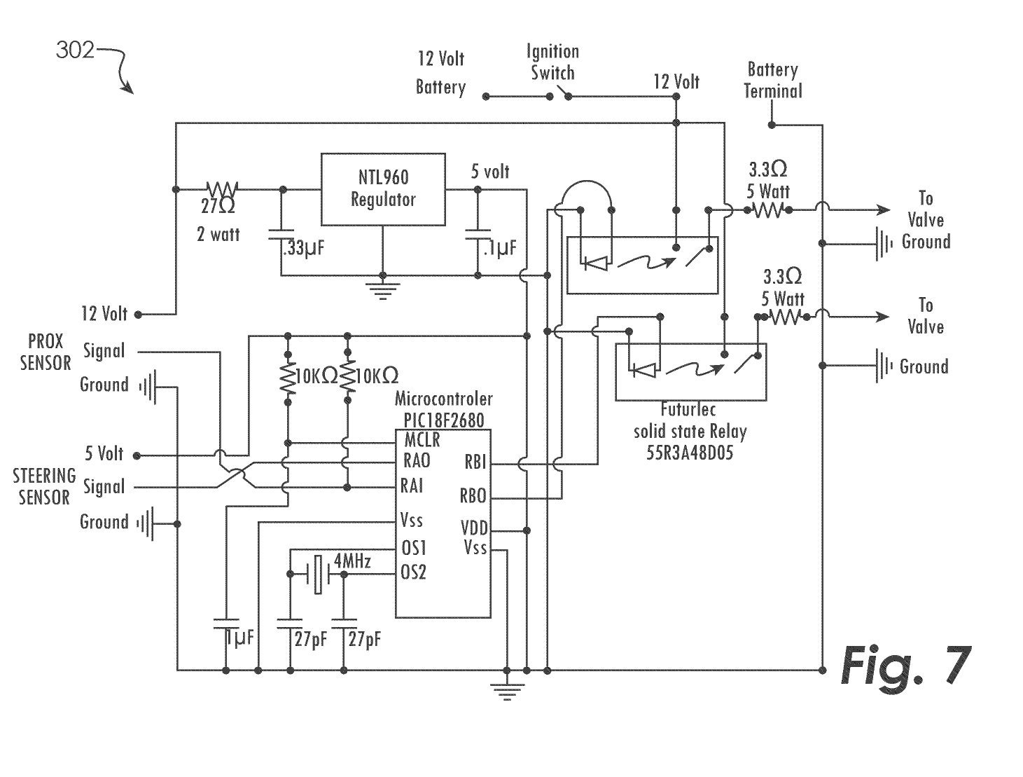

Referencing FIG. 7, the microcontroller 302 will consist of the hardware elements shown this schematic.

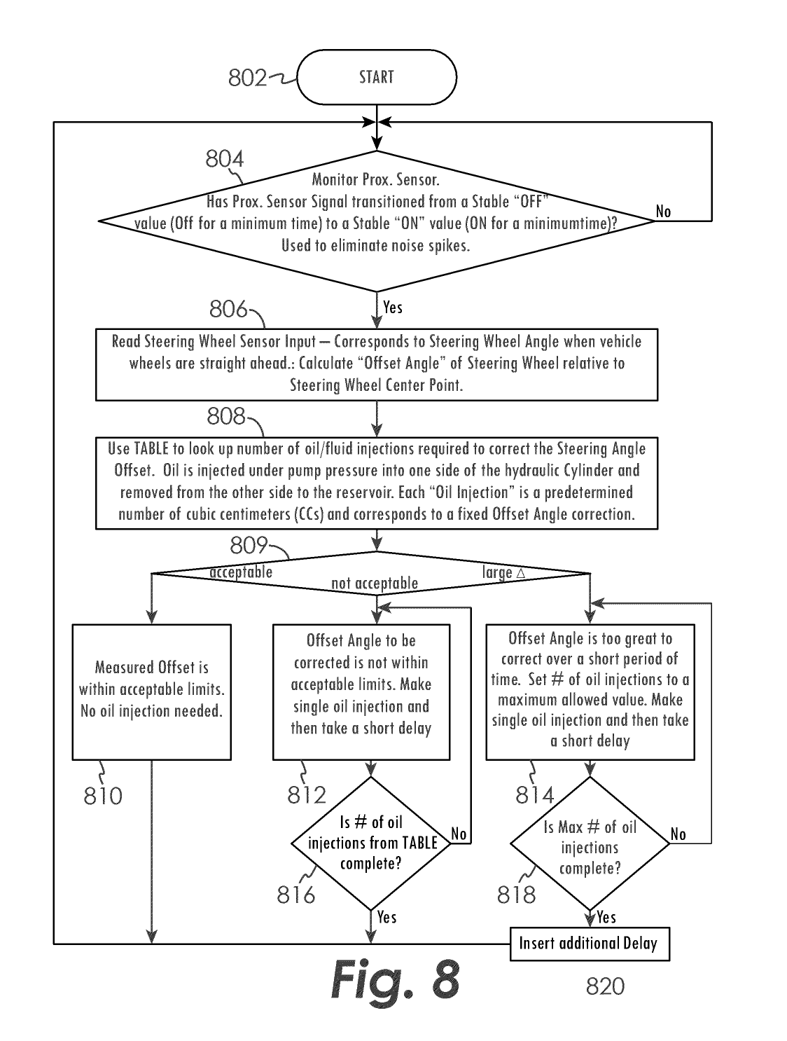

FIG. 8 illustrates a flowchart of the microcontroller software that may be used in one embodiment to keep the steering wheel and tires clocked in position. Now referencing FIG. 5 and FIG. 8: process 802 start up occurs when the vehicle power switch is turned on. Process 804: the microcontroller 302 monitors the proximity sensor 310 for stable change in on/off value indicating the piston 502 is centered in cylinder 2. Process 806: when a valid signal is obtained from the proximity sensor, the position of piston 504 is checked by reading the linear position of sensor 308. Process 808: a calculation is made and the volume of oil required to synchronize the cylinders is determined. A TABLE is used to look up number of oil/fluid injections required to correct the steering angle offset and bring the steering wheel and tires back into a clocked in position. Process 810: if the angle offset is considered acceptable, no oil/fluid injection is made. Process 812 and 816: if the condition requires a correction within specified limits, the number of oil injections is obtained from the TABLE and completed. Process 814 and 818: if the steering angle offset correction is considered too large to be made safely over a short period of time, a maximum allowed correction is made and a time delay inserted. Conditions 816, 818 and 820: when all injections are complete the program returns to condition 804 and the loop repeats.

While the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed:

1. A force feedback system comprising:
a first hydraulic cylinder operably coupled to one or more tires of a vehicle;
a power assist steering unit operably coupled to the one or more tires of the vehicle;
a second hydraulic cylinder operably coupled to the power assist steering unit; and
wherein the first and second hydraulic cylinders are hydraulically coupled to transmit force between the first and second hydraulic cylinders.

2. The force feedback system of claim 1 further comprising:
a third hydraulic cylinder operably coupled to one or more tires of a vehicle; and wherein the third hydraulic cylinder provides force to move one or more tires of the vehicle.

3. The force feedback system of claim 1 wherein,
the first hydraulic cylinder comprises a first hydraulic cylinder first end and a first hydraulic cylinder second end;
the second hydraulic cylinder comprises a second hydraulic cylinder first end and a second hydraulic cylinder second end; and
the first hydraulic cylinder first end is operably coupled to the second hydraulic cylinder second end and the first hydraulic cylinder second end is operably coupled to the second hydraulic cylinder first end.

4. The force feedback system of claim 1 wherein a force is transmitted from one of the first or second hydraulic cylinder to the other of the first or second hydraulic cylinder.

5. The force feedback system of claim 1 further comprising:
a needle valve;
one of the hydraulic cylinders comprising at least two ends; and
wherein the needle valve operably couples the at least two ends via a line.

6. The force feedback system of claim 5 wherein, the needle valve is solenoid controlled.

7. The force feedback system of claim 6 further comprising:
a microcontroller;
a sensor;
wherein the microcontroller is operably coupled to control the needle valve; and
wherein the microcontroller operates the needle valve when the sensor reads that one or more tires is no longer clocked.

8. The force feedback system of claim 1 further comprising:
a reservoir;
a valve;
a port in at least one of the first or second hydraulic cylinders; and
wherein the valve operably couples the reservoir to the port.

9. The force feedback system of claim 8 wherein the port is located at a point operative to release air trapped in the system.

10. The force feedback system of claim 9 further comprising:
a microcontroller;
a sensor; and
wherein the microcontroller operates the valve when a condition is triggered by the sensor.

11. The force feedback system of claim 10 wherein the condition is excess pressure in the force feedback system.

12. The force feedback system of claim 10 wherein the condition is excess movement in the force feedback system.

13. The force feedback system of claim 8 wherein the valve is a three position four port solenoid valve with a center position normally closed.

14. The force feedback system of claim 1 wherein the second hydraulic cylinder further comprises:
a steering rod;
a piston ballscrew nut; and
wherein the piston ballscrew nut is operably coupled to the second hydraulic cylinder and the steering rod.

15. The force feedback system of claim 1 wherein, the power assist steering unit is mechanically and hydraulically coupled to the one or more tires of a vehicle and the first hydraulic cylinder.

16. A method of operating a force feedback system comprising the steps of:
(a) calculating an offset angle between a steering wheel and a vehicle's tire;
(b) calculating the number of oil injections required to correct the offset angle; and
(c) injecting the number of oil injections to correct the offset angle.

17. The method of operating a force feedback system according to claim 16 wherein calculating the offset angle further comprises the steps of:
(a) monitoring a position sensor operably coupled to a hydraulic cylinder for a stable condition, wherein the hydraulic cylinder is operably coupled the vehicle's tire; and
(b) reading a steering wheel angle sensor operably coupled to the steering wheel.

18. The method of operating a force feedback system according to claim 16 wherein a first hydraulic cylinder is operably coupled to the vehicle's tire and a second hydraulic cylinder is operably coupled to the steering wheel.

19. The method of operating a force feedback system according to claim 18 wherein the oil injections are injected into the first hydraulic cylinder or the second hydraulic cylinder.

20. The method of operating a force feedback system according to claim 16 wherein the number of oil injections is limited by the offset angle value.
